(19) United States
(12) Patent Application Publication
(10) Pub. No.: US 2014/0180840 A1
(43) Pub. Date: Jun. 26, 2014

(54) SYSTEM AND METHOD OF CURSOR-BASED CONTENT DELIVERY

(71) Applicant: Lexos Media IP, LLC, Palo Alto, CA (US)

(72) Inventor: Craig Pisaris-Henderson, Ft. Myers, FL (US)

(21) Appl. No.: 14/044,709

(22) Filed: Oct. 2, 2013

Related U.S. Application Data
(63) Continuation of application No. 12/885,316, filed on Sep. 17, 2010.
(60) Provisional application No. 61/243,356, filed on Sep. 17, 2009.

(51) Int. Cl. G06Q 30/02

(52) U.S. Cl. CPC G06Q 30/0277
USPC 705/14.73

(57) ABSTRACT

A cursor control computer system can include a user computer supporting first program code operable to request and receive specified content information and specific cursor related images from at least one remote server, the specified content information comprising information to be displayed and at least one cursor display instruction to control presentation of the specified content information; second program code operable by the user computer to recognize the cursor display instruction in connection with processing the information to be displayed; and third program code operable on the user computer to execute cursor display code in response to the cursor display instruction, the third program code acting to display specific cursor related images and at least a portion of the specified content information.

### PRIORITY CLAIMS

This application is a continuation of U.S. patent application Ser. No. 12/885,316, which claims the benefit of U.S. Provisional Patent Application Ser. No. 61/243,356 filed on Sep. 17, 2009, the contents of which are incorporated by reference herein.

### TECHNICAL FIELD

The present invention relates generally to the delivery of content over a computer network, and more particularly relates to the delivery and display of content, such as advertising content.

### BACKGROUND

Advertising has been, and continues to be, a leading business opportunity on the Internet. The Internet, being an interactive media, offers significant advantages over traditional media in offering dynamic methods of targeting advertisements to certain audiences, publishing customizable advertisements to certain audiences and tracking the effectiveness of an advertisement by evaluating audience reaction to an advertisement.

One mechanism for Internet advertising, introduced by Comet Systems, Inc. in 1999, used the image space on a user's computer generally associated with the user's cursor to deliver an advertisement. For example, Comet Systems introduced the use of a dynamic cursor image to provide a “branded” cursor that would correspond to the content or sponsor of the web page being visited. The Comet Cursor system is described, for example, in U.S. Pat. Nos. 5,995,102, 6,118,449, 6,065,057, and 7,111,254, which are hereby incorporated by reference in their entireties.

A user's cursor is an important display space since it generally represents the user's point of focus on a particular page being displayed. Nonetheless, although Comet System, Inc.'s “comet cursor” enjoyed initial popularity, the use of cursor-based advertising has not found widespread acceptance. It is believed that improvements to the features, delivery and operation of a cursor-based content delivery system can result in the highly effective use of the cursor space as a component of a powerful advertising delivery system.

### SUMMARY

A system and method for delivering cursor-based content, such as advertising content is disclosed. In one embodiment, the system may include an advertising server having a network interface for coupling the server to a computer network. The server includes a processor having software associated therewith to implement a delivery method. The software may receive a request for cursor-based advertising content, select cursor-based advertising content based on the request, deliver the selected cursor-based advertising content, deliver instruction code for displaying the cursor-based advertising content on a user computer instead of, or in conjunction and association with, a cursor image displayed on a user's computer, and deliver instruction code for recording and reporting data related to a user's cursor position.

A method of operating a publisher server is also provided. The method may include receiving a request for content from a user, requesting cursor-based advertisement from an advertising server to deliver with the requested content, receiving the cursor-based advertisement from an advertising server, and delivering the content, the cursor-based advertisement, and instruction code for displaying the cursor-based advertisement on a display of a user computer in response to the user request for content.

A method of operating an advertising server is further contemplated. Such a method may include, for example, receiving a request for cursor-based advertising content, selecting cursor-based advertising content based on the request, delivering the selected cursor-based advertising content, delivering instruction code for displaying the cursor-based advertising content on a user computer instead of, or in conjunction and association with, a cursor image displayed on a user's computer, and delivering instruction code for recording and reporting data related to a user's cursor position. The method can further include receiving data related to a user's cursor position. In addition, the method may provide for analyzing the received data to determine user response to delivered advertising content. In response to this analysis, the method may deliver altered or replacement advertising content in response to the determined user response.

### BRIEF DESCRIPTION OF THE DRAWINGS

Embodiments of the present systems and methods are described in connection with the appended drawings, in which:

FIG. 1 is a block diagram illustrating the interaction among various operational entities in the present advertising delivery and analysis system;

FIG. 2 is an example of an internet webpage displayed on a client computer when reviewing content provided at a website presented by a publisher server;

FIGS. 3-5 are examples of web pages illustrating the use of the present cursor-based advertising system to display a cursor-based advertisement and additional promotional material related thereto;

FIG. 6 is an example of additional promotional material deliverable using the present system and methods;

FIG. 7 is a flow chart illustrating the operation of an example of a publisher server, in accordance with the current disclosure;

FIG. 8 is a flow chart illustrating the operation of an example of an advertising server, in accordance with the current disclosure; and

FIG. 9 is a pictorial representation of a configurable “container” for delivering and displaying cursor-based content in accordance with the current disclosure.

### DETAILED DESCRIPTION

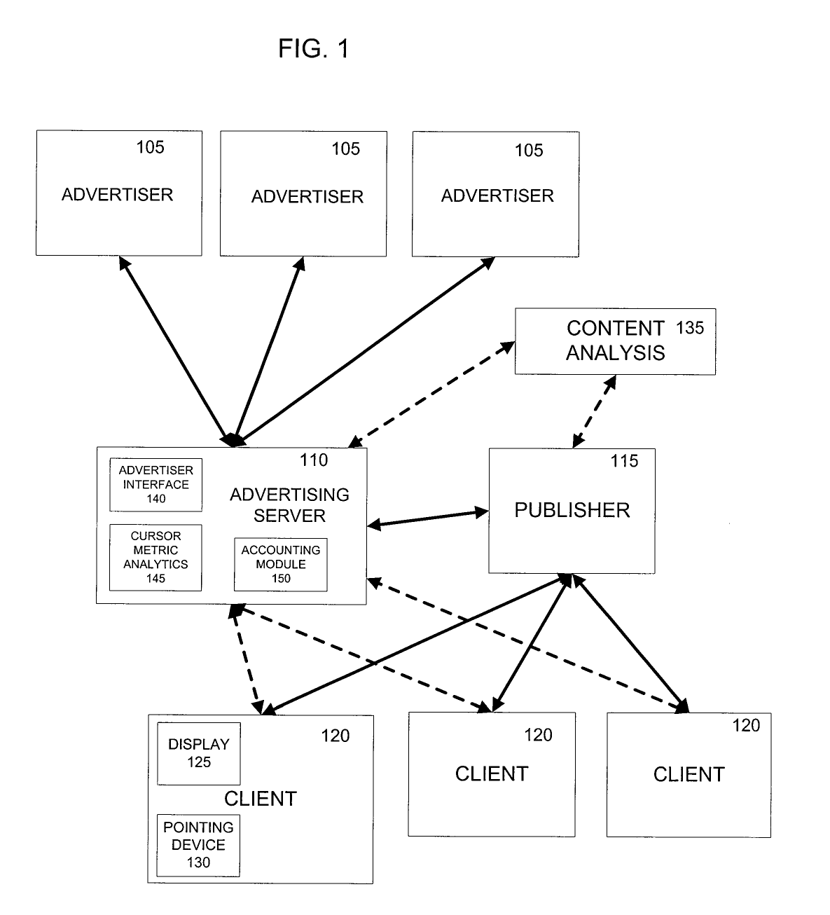

FIG. 1 is a block diagram illustrating the interaction among various operational entities in the present advertising delivery and analysis system. The present system generally provides an advertising server 110 which includes an interface to one or more advertiser computers 105. The advertising server 110 provides an account management interface 140 that allows a user of an advertiser computer to define an advertisement, define campaign parameters, review advertising metrics and the like. Typically, the account management interface includes a secure login to allow individual account owners to access and manipulate only their own accounts. The advertising server 110 also provides an interface to one or more publisher servers 115. The publisher servers 115 generally provide content to users on a computer network, such as the Internet. The publisher servers 115 also receive advertising content from the advertising server 110 for presentation to one or more client computers 120.

The client computers 120, which may include any of a number of standard computing devices such as PC, laptop, PDA, cell phone, tablet computer and the like, can be coupled to a publisher server via a computer network, such as the Internet, using known wired or wireless networking techniques. The client computers generally include a graphical user interface (GUI), including a display device 125 and a pointing device 130, such as a mouse, track ball, touch sensitive pad, touch screen and other known human interface devices. As is well known in the art, the GUI generally provides a cursor illustrating a visual position indication on the display device 125 and the position of the cursor can be controlled by the pointing device 130. In certain devices, a touch screen may be used to implement a GUI. With a touch screen interface, a cursor may not need to be displayed since the user can select any spot on the interface as a touchpoint. In such an embodiment, the present cursor based systems and methods can be applied using the touchpoint as the location to display the cursor-based content or advertisement.

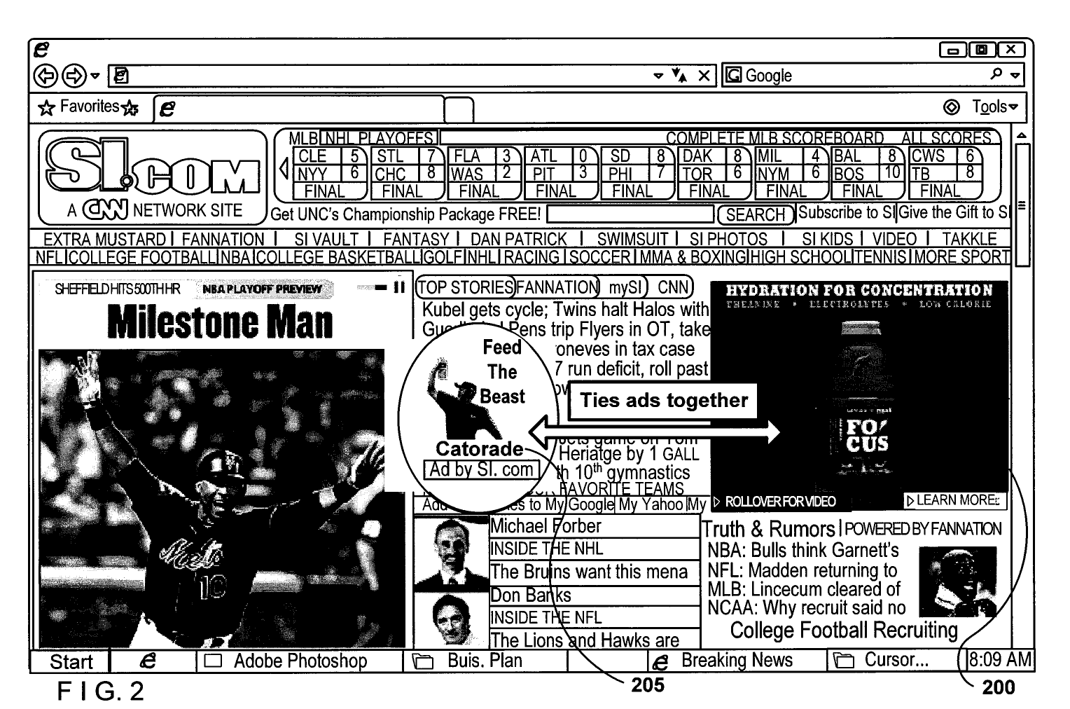

FIG. 2 is an example of an Internet webpage displayed on client computer 120 when reviewing content provided by a publisher server 115. In this example, the user of the client computer 120 is visiting a website that is focused on sports related issues. In this example, the manufacturer of a sports drink has defined an advertising campaign in the advertising server 110 that includes a traditional display or banner advertisement 200 as well as an associated cursor-based advertisement 205 that are presented to the client computer. As used herein, the term “cursor-based content” includes content, such as advertising and other image and message content, that is displayed either instead of, attached to, associated with or in conjunction with a conventional cursor image, including being displayed under, over or next to a conventional cursor image. In this case, the cursor based advertisement 205 presents an image and or text message that relates to and preferably compliments the traditional display advertisement 200. It has been found that the combination of a display advertisement with a cursor-based advertisement significantly increases advertising awareness and effectiveness when compared to using a display ad without the associated cursor-based advertisement.

In this example, the cursor-based advertisement can be presented simultaneously with the display advertisement. In order to minimize user distraction and potential annoyance, the cursor can revert to the standard cursor image after a predetermined time. For example, after five seconds, the cursor-based advertisement can fade back into a standard arrow. The cursor-based advertisement can also be displayed or removed based on some user activity. For example, if the cursor is moved over the display advertisement 200, the cursor-based advertisement image can be re-displayed (or an additional cursor-based advertisement can be displayed). Alternatively, if the user engages in some action, such as a click of a particular mouse button or performing a predetermined cursor movement, the cursor-based advertisement can be immediately replaced with a conventional cursor image. This later feature provides the user with the option of discontinuing display of the cursor-based advertisement. Alternatively, the cursor based content can also be set to deploy if a user makes certain actions, such as movement towards a back button or towards a certain location on a page.

The selection of a particular cursor-based advertisement to be displayed to the user can be based on various targeting criteria. For example, known contextual analysis techniques can be used to evaluate the subject matter of the page being viewed to determine relevant advertising content to be provided to the publisher server 115. The content being evaluated can include other advertisements that are presented on the page provided by third-party suppliers, in which case a suitable ad, either complementing or competing with the third-party advertisement, can be selected to be displayed. In addition, advertising content can be selected for delivery based on cookies, user registration information or other historical or demographic data available about the user. Further, the advertising content can be selected based upon a contextual analysis of the underlying content being viewed by the user such that a delivered cursor-based advertisement would be relevant to the underlying content. In this regard, a linguistic analysis program as known in the art can operate at the publisher server 115 or client computer 120. The linguistic analysis program evaluates the content provided to the client computer and may derive one or more keywords that are relevant to the underlying content an provide these keywords to the advertising server 110 which then identifies and delivers an appropriate advertisement to the client computer 120 either directly or via the publisher server 115. Linguistic analysis programs use various techniques to determine relevance, from simple word identification to complex analysis of the relationship of nouns, verbs, primacy, frequency and the like. The particular linguistic analysis tool used is not critical to the practice of the present system and method so long as some measure of relevance of the content to an advertisement is achieved.

The advertising content can also be selected or altered based on the time of day and/or the location of the user, if known. Other known techniques for determining advertising relevance or targeting can also be applied.

Unlike a traditional cursor graphic, which is typically limited to a 32×32 pixel display area, the present system provides for a more general display space to be defined and associated with the cursor or touchpoint location. For example, a generalized text or graphics display space can be coupled to the standard 32×32 pixel cursor display area and move in conjunction with this cursor display area as a modified cursor image. In this way, higher resolution graphics and more detailed textual information can be conveyed through the use of the modified cursor image. Preferably, when the user of the client computer addresses the publisher website, the content for the website is provided to the client computer, generally in the form of HTML, XML or other graphics/scripting based language or other suitable advertising programming code.

In the present system, the instructions that will be used by the client computer 120 to alter the cursor image from a standard image, such as an arrow, to an advertising specific image, such as the image of the spokesman for the sports drink being advertised, may be provided by the publisher website as a component of the website content code or as pass-through code supplied by the cursor advertising supplier. This allows the client computer to receive and respond to the cursor instructions without requiring the client to have previously received and installed software, such as an applet or browser plug-in, that would remain resident on the client computer or mobile device. For example, an instruction code such as <script src=“http://beta.f.adbull.com/79_{—}33.js”></script> can be imbedded in or delivered with the advertising content. This instruction identifies the location, such as on advertising server 110 that can be invoked and operated by the client computer 120. An example of the invoked code listing is set forth in Appendix 1, appended hereto. This implementation may alleviate concerns that arose with previous advertising delivery systems that the advertising delivery system was loading “spyware” or “mal-ware” onto a client computer 120.

In other embodiments, the advertising code may be integrated into an RSS feed, or any suitable Java script, XML or similar supported environment that is known in various communication interfaces, such as web browsers and custom applications such as Twitter™ for easy distribution to the client computer or mobile device.

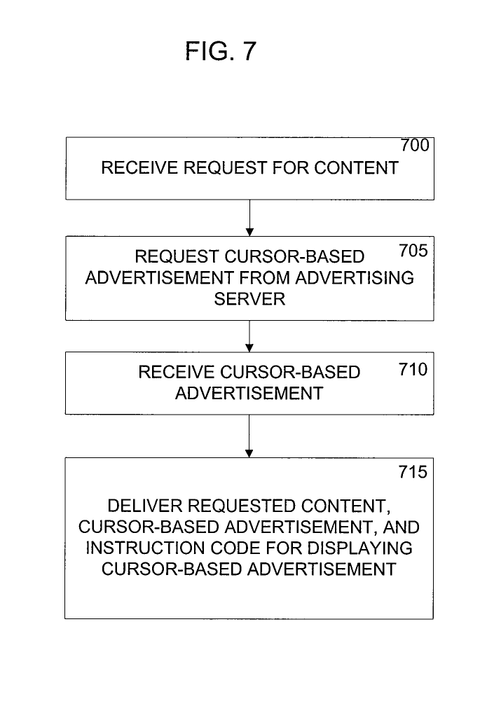

An overview of the general operation of the publishing server 110 is provided in the flow diagram of FIG. 7. When a user of a client computer 120 requests content, that request is received at publisher server 115 in block 700. The publishing server responds to the request by requesting appropriate cursor-based content from the advertising server in block 705. A number of different methods may be used by the publishing server to request relevant cursor-based content, such as by the general subject matter of the publisher website, demographic data of the user, contextual/linguistic analysis of the requested content and the like. The publisher server receives cursor based content, such as from the advertising server 110 (block 710). The publisher server 110 may also receive, along with the cursor-based content, instruction code to be provided to the client computer to enable display and tracking of the cursor based content on the client computer 120. The publisher server 115 then delivers the requested content, the cursor-based content and the instruction code for displaying the cursor based content, to the client computer 120 (block 715).

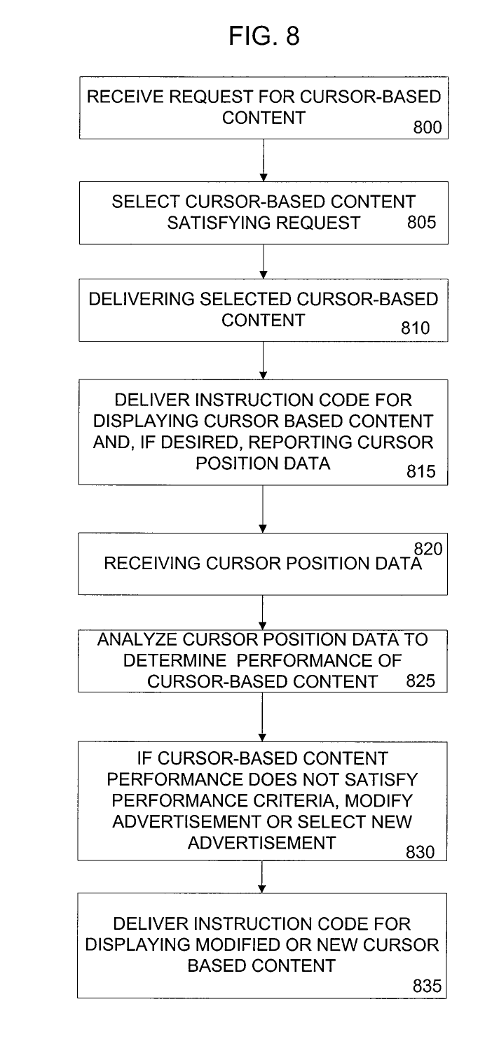

A simplified overview of the operation of the advertising server is provided in the flow diagram of FIG. 8. A request for cursor-based content is received, such as from a publisher server 110 (block 800). The advertising server then selects appropriate cursor-based content in response to the request (block 805) and delivers the selected cursor-based content, or information such as a link to the content, to the publisher server (block 810). The advertising server 110 may also provide instruction code that enables the client computer to display the cursor based content. The instruction code may also provide code for tracking and reporting a user's cursor position and other cursor related metrics (block 815). In the event that it was desired to receive and record cursor metrics, such as cursor position and time data, the advertising server may receive such data from the client computers or indirectly via the publisher server 115 (block 820). The received data, which may include but does not require personal identification information, is provided to the cursor metrics analytics engine 145 which may evaluate cursor metrics, such as cursor position versus time, cursor velocity, and the like to determine whether a particular advertisement is meeting performance targets (block 825). If it is determined that the advertisement's performance does not satisfy the performance criteria, the cursor based content can be modified in some way to attract user attention or new cursor-based content may be selected (block 830). The new or modified cursor based content can then be delivered to the publisher server 115.

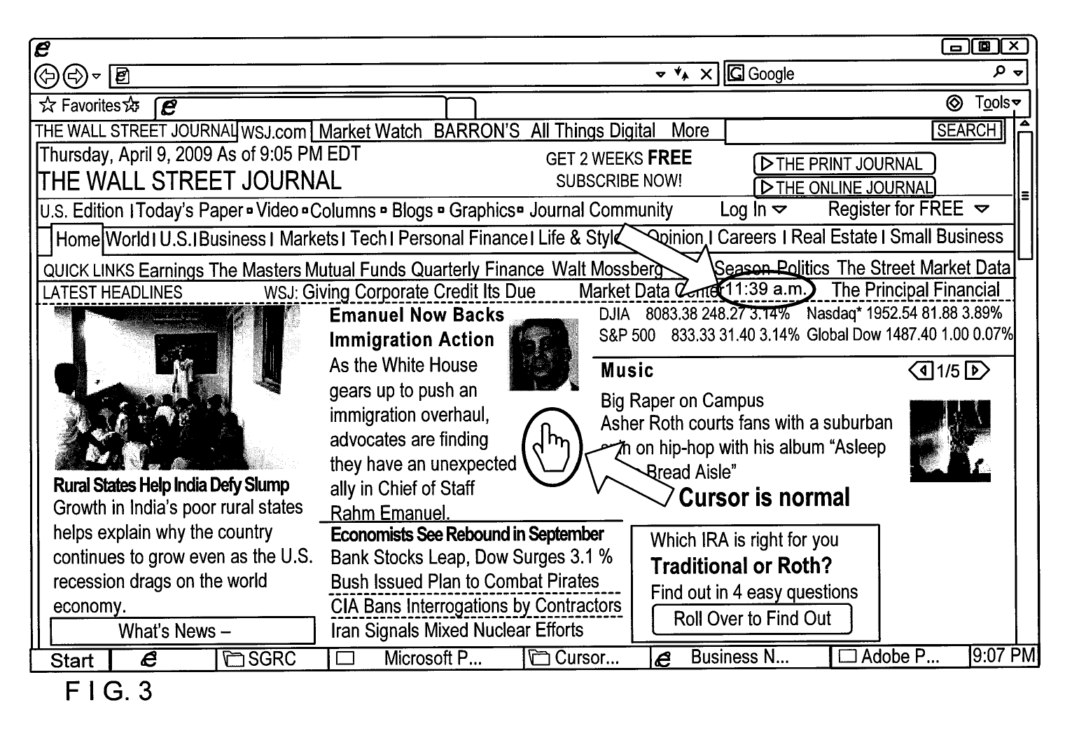

FIGS. 3-5 illustrate another example of the current cursor-based advertising system. These figures illustrate a typical progression of a cursor-based advertising sequence which includes time-based and action-based triggers for the advertising content. In FIG. 3, a client is reviewing content on a news based publisher website. When the user first enters the publisher website, no cursor-based advertisement is selected for delivery. As noted by the clock illustrated in FIG. 3, the time is 11:39 am in this first example.

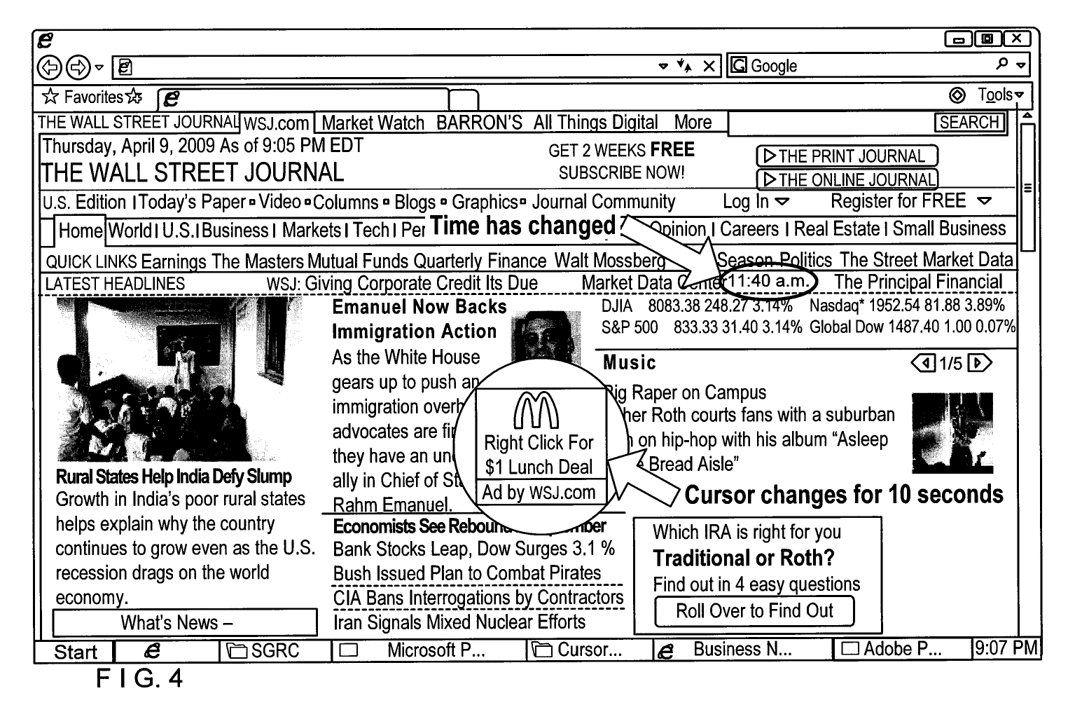

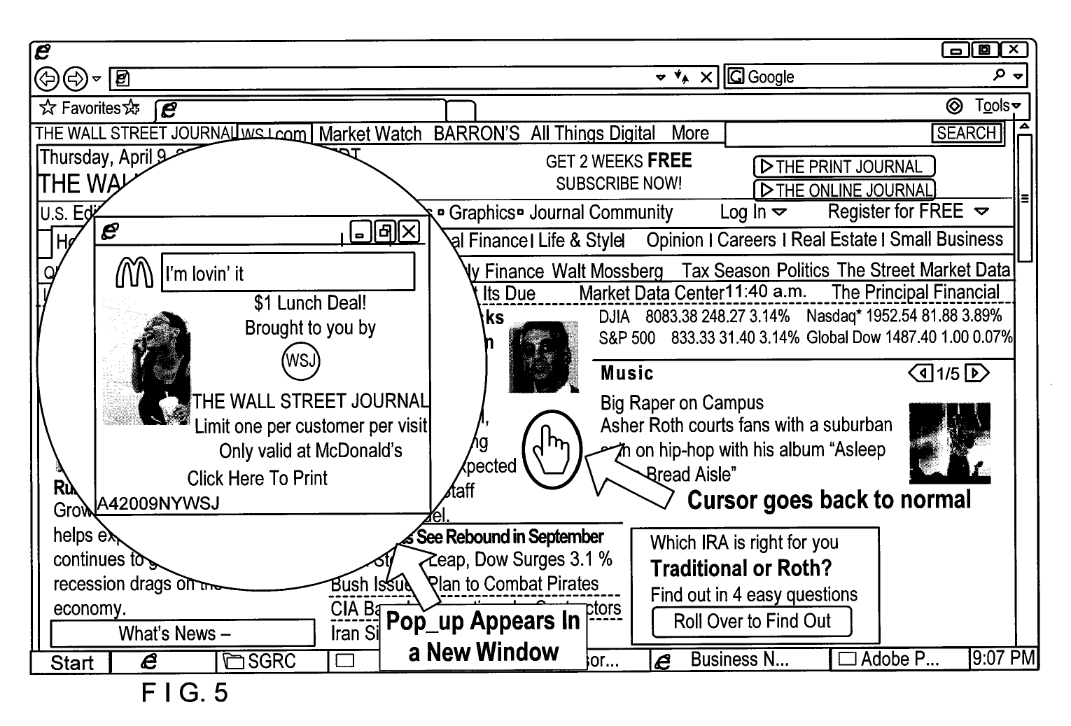

In the example illustrated in FIG. 4, the time has advanced to 11:40 am. In this example, a food vendor has created an advertising campaign that targets viewers of the publisher website at a certain time, such as between 11:40 am and 12:40 pm, for delivery of advertising content related to its restaurant. Thus, at 11:40, the cursor displayed on the client computer 120 changes from a standard cursor image, such as the hand displayed in FIG. 3, to the logo and message provided in FIG. 4. The cursor-based advertisement of FIG. 4 further includes the invitation to “right click for $1 lunch deal,” prompting the user to take further action and thereby receive a coupon or further promotional material, such as illustrated in FIG. 5. The cursor can continue to display the cursor-advertisement for a predetermined amount of time, until some activity at the client computer 120 is detected, or some combination of time and activity. For example, the advertisement can be displayed continuously so long as no cursor motion is detected and then change back to the standard cursor image following a predetermined time after some cursor movement is detected. This will provide an opportunity for the advertisement to be seen by the user even if they are away from the computer momentarily when the advertisement is first displayed, yet also revert to the standard image in a timely fashion to minimize user annoyance.

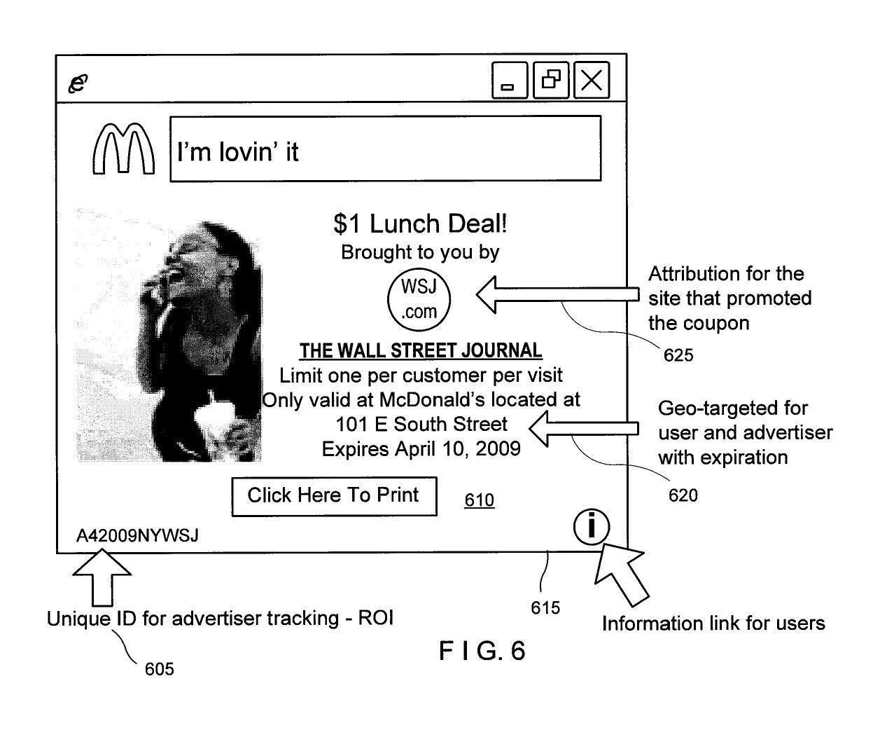

As illustrated in FIG. 6, the coupon or promotional material provided to the user after an invited action associated with the cursor-based advertisement can include a number of features. For example, the promotional material can include a unique identifier that facilitates advertiser tracking of the promotion. This is helpful to the advertiser to determine the effectiveness of the promotion and to calculate return on investment (ROI) for the promotion. The promotion can also include an action button to print a redeemable coupon. The promotion can also include an information link 615 that can, for example, include a description of the advertising service delivering the cursor based advertisement. In certain instances, the approximate geographic location of the user can be determined based on user demographics or more precisely determined if the client computer has a positioning system, such as Global Positioning System (“GPS”) capability. When geo-tracking techniques are used, or the user's location is otherwise known, the promotion can be geo-targeted, such as by specifying a specific address or region where the coupon may be redeemed. For example, as illustrated in FIG. 6, the promotional material can be generic to a brand, or can be specifically targeted to a particular address when geo-targeting establishes that the user is close to a particular location for that brand, such as “101 E. South Street.”

The current system also contemplates the use of cursor position and motion to determine, at least in part, user behavior and advertisement responsiveness. Based on a study comparing eye-tracking and mouse pointer behavior, it has been shown that over 80% of the time a user moves their mouse cursor to an area of their screen, that same area was also looked at by the user. Similarly, this study demonstrated that approximately 88% of the time, regions that were not subject to eye-gaze were also not visited by the mouse cursor. Thus, there is believed to be a strong correlation between cursor location and eye-gaze.

Recognizing this phenomenon, it is believed that cursor position may be used as a reasonable proxy for determining where on a display a user's attention is drawn. By providing feedback from the client computer 120 on cursor position in connection with advertising variables, such as time, display advertising content, cursor-based advertisement content and the like, the effectiveness of various advertising vehicles in capturing the attention of a user can be measured using the current system. In this regard, the software embedded in the delivered advertisement may include instructions that allow the tracking and reporting of cursor position, such as to the advertising server 110. Alternatively, other servers, not shown, may receive and process the cursor data. This client computer may provide data regarding cursor coordinates, time stamps, and the like, which are readily accessible parameters on a typical graphical user interface in a client computer or mobile device. This information can be sent to a cursor metrics analytics engine 145 residing in the advertising server 110, or other computer server, without requiring personal identifying information (PII) and still provide useful feedback regarding the performance of the advertisement. If the client has authorized the release of PII, this information can be incorporated into that client's user profile to improve the delivery of future advertisements and services. This can be beneficial in CPM based display advertising, where an advertisement may be effective at enhancing brand reputation by being viewed even if there is no immediately measurable performance-based metric, such as a click-through, associated with the display of that advertisement.

In addition to cursor position, cursor movement in response to various events and relative dwell time of the cursor in certain locations on the display can also provide meaningful data regarding the effectiveness of an advertisement. For example, the direction of cursor movement towards or away from an advertisement being displayed may be an indication of relative interest in the advertising content. Further, the location within the advertising content that a cursor visits may also be indicative of which portion of the advertising content is most significant to the user. Thus, the advertising code provided with the cursor-based advertisement preferably includes code for determining cursor position and reporting the cursor position, and other desirable metrics, back to the advertising server. Cursor position can be used for post-display analytics as well as for dynamically controlling the advertising content to promote a further response. For example, if a particular cursor-based advertising image does not result in a desired cursor action, the content can be altered to capture the viewer's attention and promote further action. The cursor position data can also be presented to advertisers in various forms on an advertiser interface. For example, “heat maps” illustrating a color coded depiction of frequency of cursor position may be presented to visualize the regions of the display most frequented by the cursor. Other forms of data presentation, such as graphs and topographical charts, illustrating various cursor metrics can also be used to assist an advertiser in evaluating the effectiveness of particular advertising. Each of these functions may be performed in the cursor metrics analytics engine 145.

The use of dynamic changes in advertising content can alter the cursor-based advertisement, a display advertisement or both. As an example, referring to FIG. 2, if after 20 seconds of displaying the advertisement for the sports drink, no favorable cursor activity was detected (e.g., cursor movement over or towards the advertisement) a new cursor based image could be presented that more actively directs the user's attention to the display ad. This can be by way of a graphic that directs the user's attention towards the display add (such as by changing the image of the spokesman on the cursor-based advertisement to point towards the display advertisement) or by a simple text message, such as “see our ad on this page.”

It is known that a touch screen may be used to implement a GUI in a computing device. Indeed, such interfaces have grown in popularity, particularly in mobile devices, such as cellular phones, music players and tablet computers. With a touch screen interface, a cursor may not need to be displayed since the user can select any spot on the interface as a touchpoint. In such an embodiment, the present cursor based systems and methods can still be applied. In a touch screen device, the touchpoint is used as the location of the cursor-based advertisement. In a similar manner to that described above, various touchpoint based advertising can be delivered. Similar to cursor position, data regarding the location of touchpoints over time can be monitored and reported by the client computer. In a similar manner as described above with respect to cursor position, touchpoint position can also be used in performing the analytic methods described above.

The advertising server 110 may also include an accounting module 150 (in FIG. 1) to track advertising delivery and performance metrics and to assist in billing and revenue distribution functions. As is known in the art of network based advertising delivery, there are a number of revenue models that can be applied to advertising delivery. For example, an advertiser may pay to have an advertisement delivered to a certain number of users using a so-called CPM, or cost per thousand page view model. In this case, the advertising server would account for the number of times the advertisement was served and would base the advertising delivery charge on this number. Various performance based models, such as pay-per-click, pay for purchase and the like are also known. In such models the advertising server will track not only the number of times that an advertisement was delivered, but would also track the relevant performance based metric. The advertising server may also track the particular publisher server that requested and delivered the advertisement to provide an account record for any applicable revenue sharing relationship that may be in place between the operator of the advertising server 110 and the publisher server 115. The specific implementation of the accounting module is not critical to the practice of the present systems and methods and those skilled in the art understand how to implement appropriate accounting modules for the various billing and revenue models.

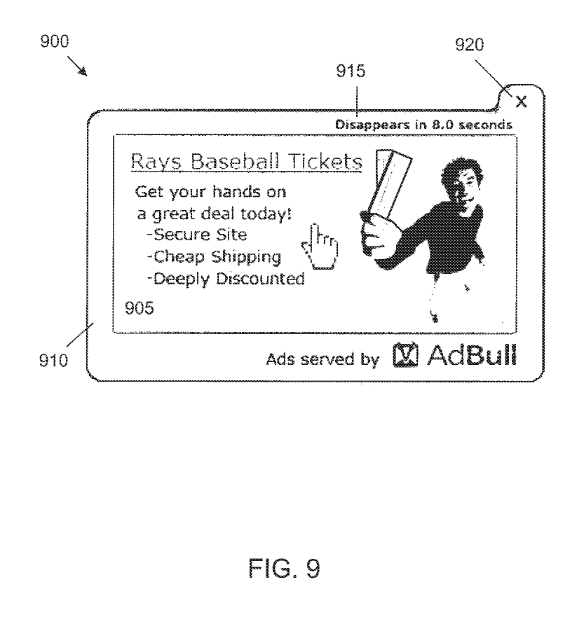

Another aspect of the present systems and methods is the use of a “container” for delivering cursor based content. Referring to FIG. 9, the container 900 can accept either standard IAB dimensioned or non-IAB standard advertising units 905, within the container frame 910. In addition, the container 900 allows an advertiser, via the advertiser interface 140, to configure various features and options associated with the presentation of the cursor-based content. For example, the container may be configured to only display for a certain amount of time, which can be graphically displayed with the container either by a count down timer or graphical indication of the remaining time, such as an hour glass or other time-based symbol. The container definition can also include a specification that allows the cursor-based content to separate itself from the cursor after a predetermined action or period of time. As an example, after a predetermined time or a user clicking the X symbol 915 on the container, the cursor based content can detach from the current cursor position and move to a position on the display specified in the container parameters, such as top left, top right, bottom left, bottom right, or any particular X-Y coordinate specified by the advertiser and embedded in the container specification.

The foregoing discussion describes some example embodiments to perform cursor-based content delivery. Although the foregoing discussion has presented specific embodiments, persons skilled in the art will recognize that changes may be made in form and detail without departing from the spirit and scope of the embodiments.

What is claimed is:

1. A cursor control computer system, comprising:
a user computer supporting first program code operable to request and receive specified content information and specific cursor related images from at least one remote server, the specified content information comprising information to be displayed and at least one cursor display instruction to control presentation of the specified content information;
second program code operable by the user computer to recognize the cursor display instruction in connection with processing the information to be displayed; and
third program code operable on the user computer to execute cursor display code in response to the cursor display instruction, the third program code acting to display specific cursor related images and at least a portion of the specified content information.

2. The cursor control computer system claim 1, wherein the at least one remote server is a prespecified server, and the first program code requests and receives specified content information and specific cursor related images from the prespecified server.

3. The cursor control computer system claim 1, wherein the at least one remote server is a prespecified server, and further comprising program code operable to retrieve cursor display code from a prespecified server.

4. The cursor control computer system claim 1, wherein the at least one remote server is an authorized server, and further comprising program code operable to determine whether cursor display instructions were transmitted by the authorized server.

5. The cursor control computer system claim 1, further comprising program code operable to transmit statistical information to at least one remote server to provide information relating to the usage of specific cursor related images.

6. The cursor control computer system claim 1, wherein the third program code is further operable on the user computer to revert specific cursor related images back to original appearances after a prespecified duration.

7. The cursor control computer system claim 1, wherein the third program code is operable to display specific cursor related images received and stored in permanent memory in response to a request initiated during execution of the first program code.

8. The cursor control computer system claim 1, wherein the third program code is operable to display specific cursor related images received and cached in local memory in response to a request initiated during execution of the first program code.

9. The cursor control computer system claim 1, wherein the third program code is operable to immediately display specific cursor related images received in response to a request initiated during execution of the first program code.

10. A cursor control computer system comprising:
a user computer supporting first program code operable to request and receive specified content information and specific cursor related images from at least one remote server, the specified content information comprising information cached in local memory of the user computer for display during an occasion of user interaction with the user computer, and at least one cursor display instruction to control presentation of the specified content information;
second program code operable on the user computer to recognize the cursor display instruction in connection with processing the information to be displayed; and
third program code operable to execute cursor display code in response to the cursor display instruction, the third program code operable during the occasion of user interaction to display specific cursor related images and at least a portion of the specified content information.

11. The cursor control computer system of claim 10, wherein the first program code is operable on the user computer to request and receive specified content information and specific cursor related images from a prespecified remote server.

12. The cursor control computer system of claim 10, further comprising program code operable on the user computer to retrieve cursor display code from a prespecified remote server.

13. The cursor control computer system of claim 10, further comprising program code operable on the user computer to determine whether cursor display instructions were transmitted by a remote server that is an authorized server.

14. The cursor control computer system of claim 10, further comprising program code operable on the user computer to transmit statistical information to at least one remote server to provide information relating to the usage of specific cursor related images.

15. The cursor control computer system of claim 10, wherein the third program code is further operable to revert specific cursor related images back to original appearances after a prespecified duration.

16. The cursor control computer system of claim 10, wherein program code is further operable to provide audio information corresponding to display of specific cursor related images.

17. The cursor control computer system of claim 10, wherein program code is further operable on the user computer to provide animated images corresponding to display of specific cursor related images.
